(19) United States
(12) Patent Application Publication
(10) Pub. No.: US 2026/0235469 A1
(43) Pub. Date: Aug. 13, 2026

(54) JIG AND METHOD FOR DETECTING MISASSEMBLY OF GASKET

(71) Applicant: Yazaki Corporation, Tokyo (JP)

(72) Inventors: Sota ARAI, Shizuoka (JP); Masato AKINO, Shizuoka (JP); Yasuhiro TANAKA, Shizuoka (JP); Yasuhiro OTSUTA, Shizuoka (JP); Masatoshi YAMADA, Shizuoka (JP); Yusuke TSUTAGAWA, Shizuoka (JP)

(73) Assignee: Yazaki Corporation, Tokyo (JP)

(21) Appl. No.: 19/451,527

(22) Filed: Jan. 16, 2026

(30) Foreign Application Priority Data
Feb. 13, 2025 (JP) 2025-021233

(51) Int. Cl. G01M 3/28

(52) U.S. Cl. CPC G01M 3/2869

(57) ABSTRACT

A jig includes: a sealing surface that faces one end surface in an axial direction of a gasket assembled to a housing of a terminal block; and groove portions that are provided in the sealing surface and are capable of accommodating at least a part of a lip portion projecting along the axial direction from the one end surface of the gasket. The lip portion is formed in an annular shape along the gasket, and the sealing surface has a plurality of groove portions at intervals along a circumferential direction of the gasket and enables the lip portion to be partially accommodated in the groove portions.

### CROSS-REFERENCE TO RELATED APPLICATION(S)

The present application claims priority to and incorporates by reference the entire contents of Japanese Patent Application No. 2025-021233 filed in Japan on February 13, 2025.

### BACKGROUND OF THE INVENTION

### Field of the Invention

The present invention relates to a jig and a method for detecting misassembly of a gasket.

### Description of the Related Art

As a technology related to a jig and a method for detecting misassembly of a gasket in the related art, for example, Japanese Patent Application Laid-open No. JP 2024 - 082 080 A discloses a terminal block including a housing and a gasket held by a flange portion of the housing. The gasket has a main body annular portion having an annular shape and an extension piece having a cantilever shape extending outward from the main body annular portion. The extension piece has a hinge portion which is bendable into a shape projecting toward a peripheral edge portion, and a locking portion which is provided at an extension end of the hinge portion, and the flange portion has a groove portion into which the extension piece is fitted, and a bridge portion which has a bridge shape connecting groove walls of the groove portion and is capable of locking the locking portion.

Incidentally, in the terminal block of the related art, for example, a lip portion of the gasket is assembled in a correct posture facing the housing side, but the lip portion may be assembled in an incorrect posture facing a partition wall side, and there is still room for further improvement in appropriate operation for detecting such misassembly of the gasket.

### SUMMARY OF THE INVENTION

The present invention has been made in view of the circumstances, and an object of the present invention is to provide a jig and a method for detecting misassembly of a gasket which are capable of appropriately performing operation for detecting misassembly of a gasket.

In order to achieve the above mentioned object, a jig according to one aspect of the present invention includes a sealing surface that faces one end surface in an axial direction of a gasket assembled to a housing of a terminal block; and groove portions that are provided in the sealing surface and are capable of accommodating at least a part of a lip portion projecting from the one end surface of the gasket along the axial direction.

In order to achieve the above mentioned object, a method for detecting misassembly of a gasket according to another aspect of the present invention includes a first step of attaching, to a sealing surface of a jig, one end surface in an axial direction of a gasket assembled to a housing of a terminal block; a second step of accommodating, into groove portions provided in the sealing surface, at least a part of a lip portion of the gasket projecting along the axial direction from the one end surface as the sealing surface and the one end surface are brought into close contact with each other; and a third step of detecting leakage of an air flow by sending the air flow between the sealing surface and the one end surface from an air leak tester, and detecting misassembly of the gasket based on whether or not the air flow leaks.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary configuration diagram of a detection device to which a jig according to an embodiment is applied;

FIG. 2 is an exemplary plan view of the jig and a terminal block according to the embodiment;

FIG. 3 is an exemplary exploded perspective view of the jig and the terminal block according to the embodiment;

FIG. 4 is an exemplary exploded perspective view of the jig and the terminal block according to the embodiment from an angle different from that in FIG. 3;

FIG. 5 is an exemplary plan view of the jig according to the embodiment;

FIG. 6 is an exemplary cross-sectional view of the jig and a gasket of the terminal block according to the embodiment;

FIG. 7 is an exemplary cross-sectional view illustrating a method for detecting misassembly of the gasket according to another embodiment;

FIG. 8 is an exemplary flowchart of the method for detecting misassembly of the gasket according to the embodiment;

FIG. 9 is an exemplary plan view of a jig according to a modification example; and

FIG. 10 is an exemplary cross-sectional view of the jig and a gasket of a terminal block according to the modification example.

### DETAILED DESCRIPTION OF THE PREFERRED EMBODIMENTS

Hereinafter, embodiments and modification examples according to the present invention will be described in detail with reference to the drawings. Note that this invention is not limited by the following embodiments and modification examples. In addition, constituent elements in the following embodiments and modification examples include a constituent element with which those skilled in the art can easily replace any one of the constituent elements or a constituent element that is substantially the same as any one of the constituent elements.

In addition, the embodiments and modification examples disclosed below include similar constituent elements. Therefore, in the following description, common reference numerals are assigned to these similar components, and the redundant descriptions thereof are omitted. Note that, in the present specification, ordinal numbers are used only to distinguish between components, members, parts, positions, directions, or the like, and do not indicate the order or priority.

### Embodiments

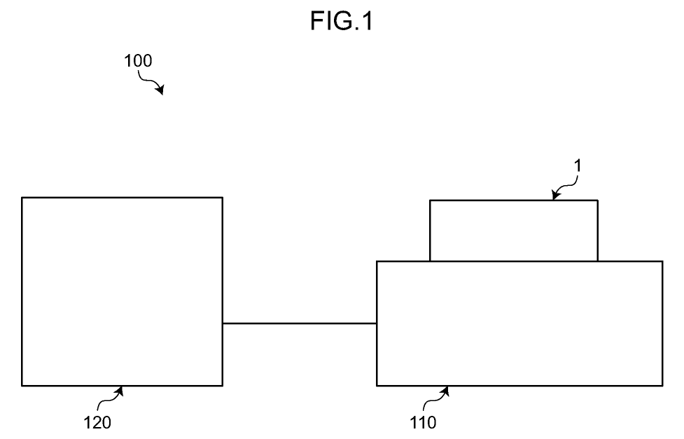

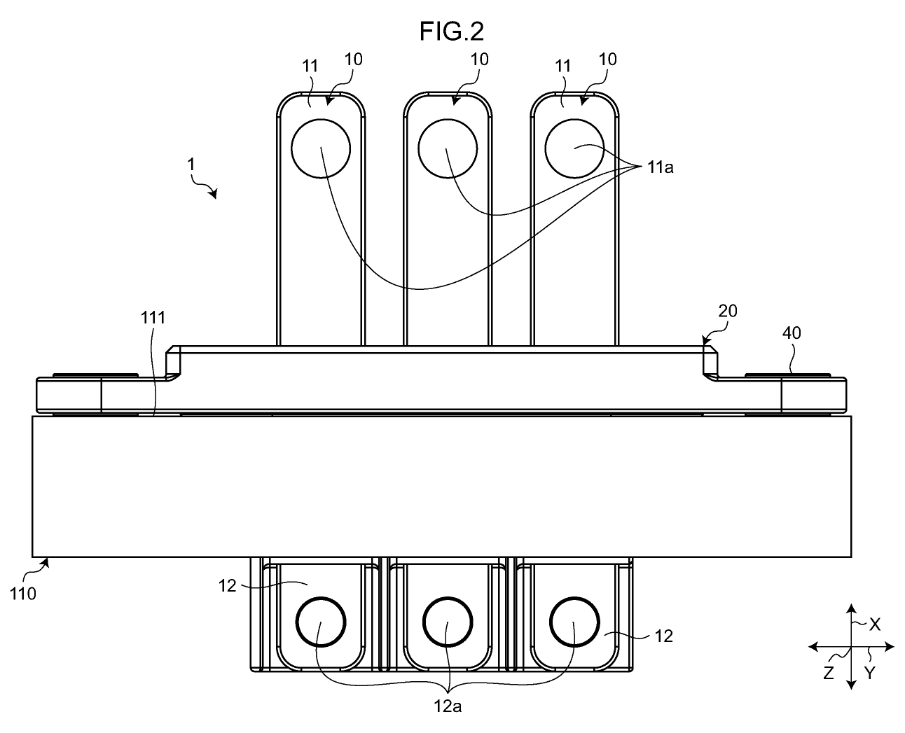

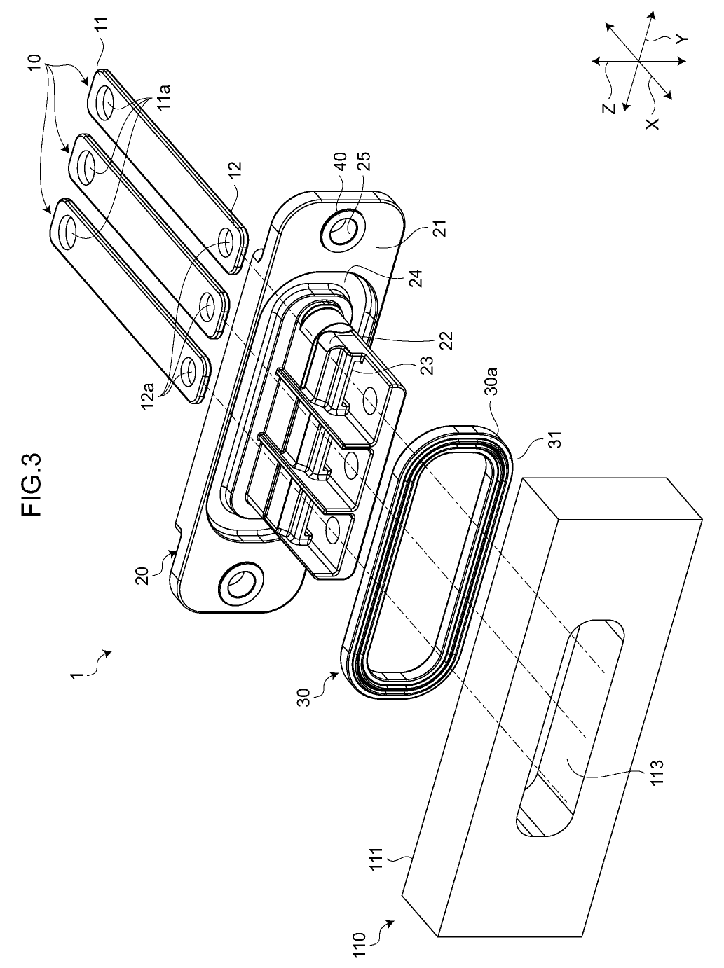

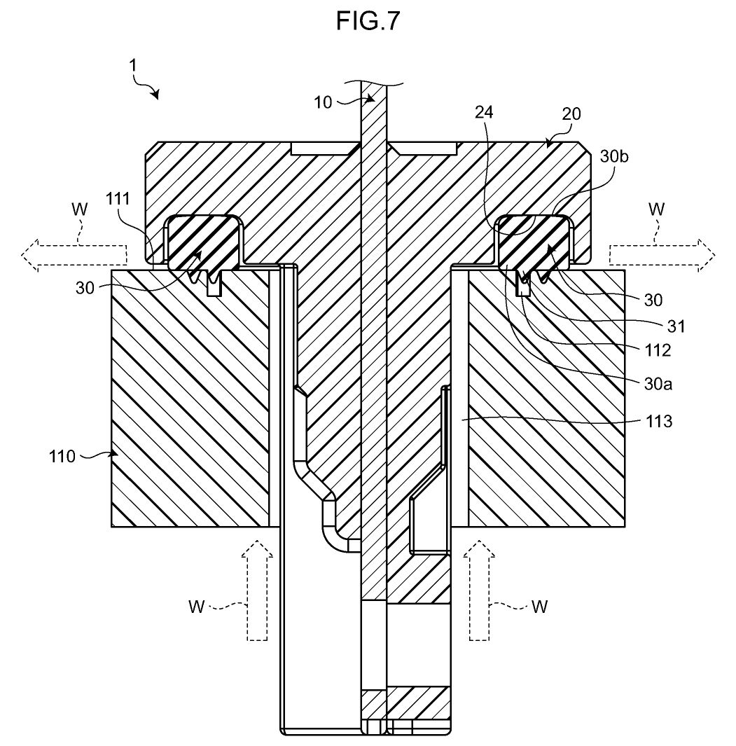

FIG. 1 is a configuration diagram of a detection device 100 to which a jig 110 according to an embodiment is applied, and FIG. 2 is a plan view of the jig 110 and a terminal block 1. The jig 110 of the embodiment illustrated in FIGS. 1 and 2 is incorporated in, for example, the detection device 100 that detects misassembly of a gasket 30 (see FIG. 3) to a housing 20 , the gasket 30 being assembled to the housing 20 of the terminal block 1. The detection device 100 includes, for example, the jig 110 that is attached to the gasket 30 of the terminal block 1, and an air leak tester 120 that sends an air flow W (see FIG. 7) between the jig 110 and the gasket 30.

The terminal block 1 is mounted on a vehicle such as an electric car or a hybrid car, for example, and relays electrical connection between a first device and a second device (not illustrated). In the terminal block 1, an external terminal of the first device is electrically connected to a first connection portion 12 provided at one end portion of a busbar 10, and an external terminal of the second device is electrically connected to a second connection portion 11 provided at the other end portion of the busbar 10. The first device is, for example, one of a motor and an inverter, and the second device is, for example, the other of the motor and the inverter. Note that the terminal block 1 is not limited to this example, and may be used for, for example, relaying between the first device or the second device and a routing member, relaying between a routing member and a routing member, or the like.

Note that, in the following description, among a first direction, a second direction, and a third direction intersecting each other, the first direction is referred to as an "axial direction X", the second direction is referred to as a "width direction Y", and the third direction is referred to as a "height direction Z". Here, the axial direction X, the width direction Y, and the height direction Z are substantially orthogonal to each other. The axial direction X typically corresponds to a depth direction (front-rear direction) of the terminal block 1, an axial direction of a central axis of the gasket 30, a plate thickness direction of the jig 110, or the like. The width direction Y typically corresponds to a width direction (left-right direction) of the terminal block 1 and the jig 110, a radial direction of the gasket 30, or the like. The height direction Z typically corresponds to a height direction (up-down direction) of the terminal block 1 and the jig 110, a radial direction of the gasket 30, or the like. In addition, any direction used in the following description will be described as a direction in a state in which the terminal block 1 is assembled to the jig 110 unless otherwise specified.

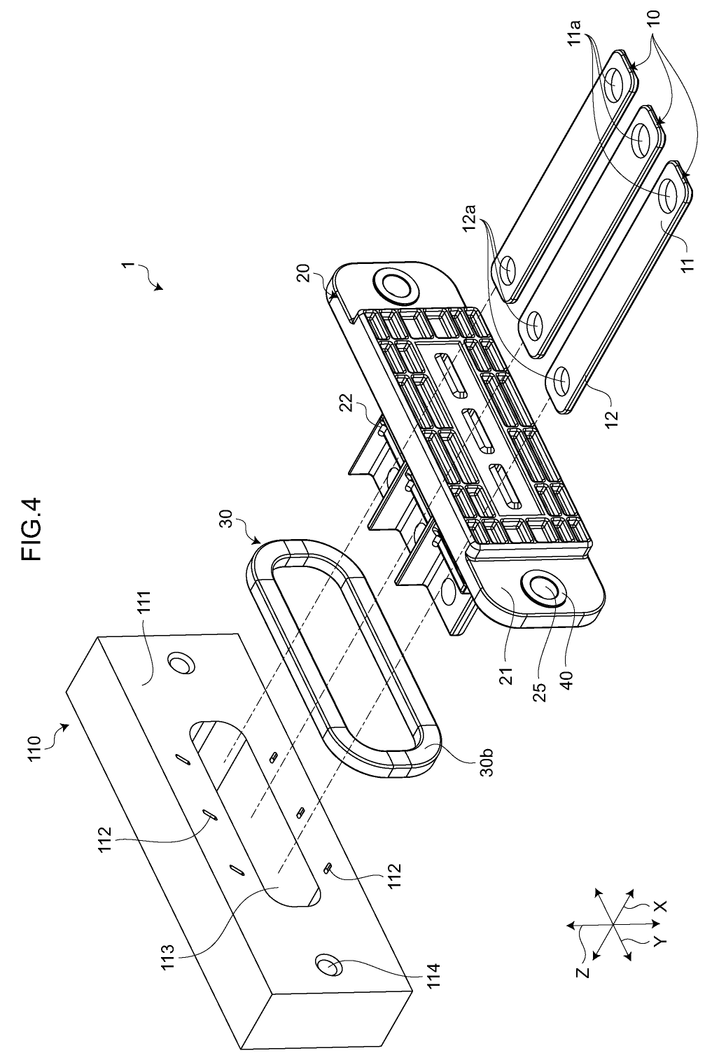

FIG. 3 is an exploded perspective view of the jig 110 and the terminal block 1, and FIG. 4 is an exploded perspective view of the jig 110 and the terminal block 1, as a view from an angle different from that in FIG. 3. As illustrated in FIGS. 3 and 4, the terminal block 1 includes, for example, a plurality of the busbars 10, the housing 20, and the gasket 30. The busbar 10 is a terminal fitting made of a conductive metal material and is electrically connected to the above-described external terminal. In the embodiment, the terminal block 1 includes three busbars 10 that are provided side by side along the width direction Y.

The busbar 10 includes, for example, a first connection portion 12 provided at one end portion in the axial direction X and a second connection portion 11 provided at the other end portion in the axial direction X. The first connection portion 12 and the second connection portion 11 are integrally made of a conductive metal material and extend along the axial direction X. The first connection portion 12 and the second connection portion 11 have respective through-holes 12a and 11a in which fastening members such as bolts that fasten the busbar 10 and the external terminals are attached.

The housing 20 holds the busbar 10, the gasket 30, and the like and is made of an insulating synthetic resin material or the like. The housing 20 includes, for example, a housing main body 21 and a projecting portion 22 projecting along the axial direction X from the housing main body 21. The housing main body 21 has, at both end portions in the width direction Y, attachment holes 25 in which fastening members such as bolts that fasten the housing 20 and the jig 110 or an attachment target object (not illustrated) are attached. The attachment hole 25 is a through-hole penetrating the housing main body 21 along the axial direction X. The attachment hole 25 has, for example, a collar 40 that prevents contact between a bolt (metal) and the housing main body 21 (resin).

The housing main body 21 and the projecting portion 22 have insertion space portions 23 into which the busbars 10 are inserted along the axial direction X. The insertion space portions 23 are opening portions penetrating the housing main body 21 and the projecting portion 22 along the axial direction X. In the embodiment, the housing 20 has the three insertion space portions 23 corresponding to the busbars 10, and these three insertion space portions 23 are partitioned from each other along the width direction Y.

In addition, the housing main body 21 has a recess 24 that holds the gasket 30. The recess 24 is recessed from one end surface of the housing main body 21 in the axial direction X toward the other end surface side in the axial direction X and is open toward the one end surface side in the axial direction X. The recess 24 is provided, for example, at a peripheral edge portion of the projecting portion 22 and is formed in a substantially elliptical annulus shape along the outer shape of the gasket 30. In the housing 20, the housing main body 21 and the projecting portion 22 are integrally formed.

The gasket 30 prevents foreign matter such as moisture from entering an inside of the housing 20. The gasket 30 is made of, for example, an elastically deformable material such as rubber or resin. The gasket 30 is formed in a substantially elliptical annulus shape, for example, and is inserted into the above-described recess 24. The gasket 30 is interposed between a bottom surface of the recess 24 and the jig 110 or an attachment target object (not illustrated) in a state in which the terminal block 1 is attached to the jig 110 or the attachment target object. The gasket 30 is also called an O-ring or the like.

In addition, the gasket 30 has a plurality of lip portions 31 on one end surface 30a in the axial direction X. The lip portion 31 is a pleated water stop portion formed in a substantially elliptical annulus shape along the outer shape of the gasket 30 and projects along the axial direction X from the one end surface 30a. In the embodiment, the gasket 30 has two lip portions 31 provided side by side in the radial direction of the gasket 30. In a case where the gasket 30 is assembled into the recess 24 of the housing 20 in a correct posture in which the two lip portions 31 face the bottom surface side of the recess 24 (an opposite side to the jig 110), the two lip portions 31 are brought into close contact with the bottom surface of the recess 24 to stop water between the two lip portions 31 and the bottom surface. On the other hand, in a case where the gasket 30 is assembled into the recess 24 of the housing 20 in an incorrect posture in which the two lip portions 31 face the jig 110 side, the two lip portions 31 are brought into close contact with a sealing surface 111 of the jig 110.

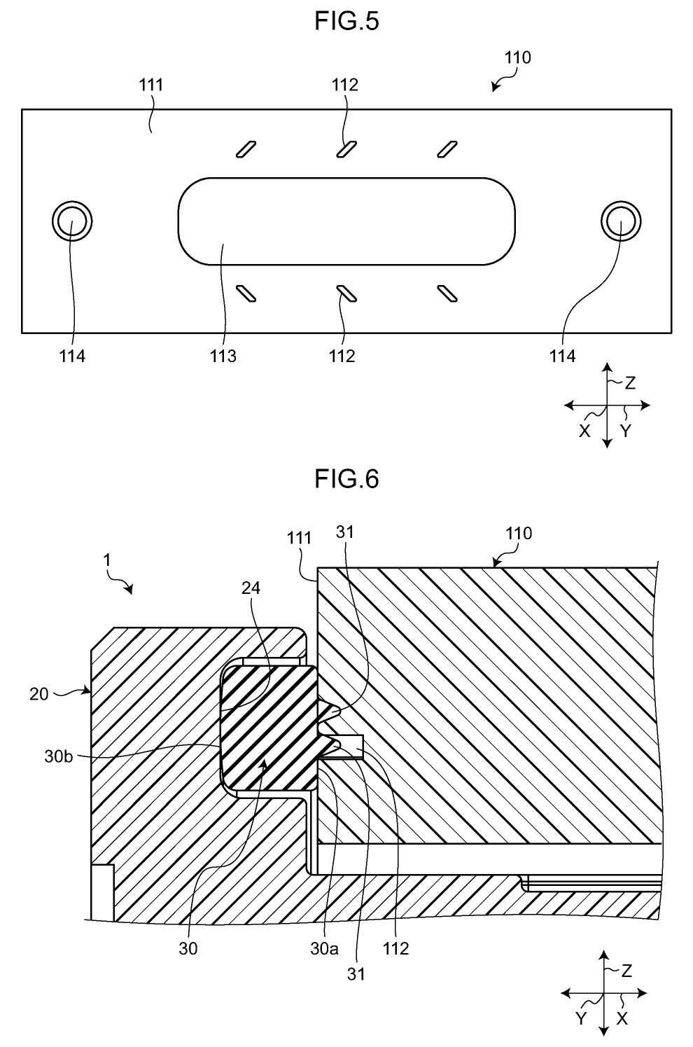

FIG. 5 is a plan view of the jig 110, and FIG. 6 is a cross-sectional view of the jig 110 and the gasket 30 of the terminal block 1. As illustrated in FIGS. 5 and 6, the jig 110 is formed in a flat rectangular box shape along the axial direction X, for example. The jig 110 has, at both end portions in the width direction Y, attachment holes 114 in which fastening members such as bolts to be fastened to the above-described housing 20 are attached. The attachment hole 114 is, for example, a recess recessed along the axial direction X, and the recess has, in an inner surface, a female thread portion meshing with a male thread portion of the bolt. In addition, the jig 110 has, in a central portion, an insertion hole 113 into which the projecting portion 22 of the above-described housing 20 is inserted along the axial direction X. The insertion hole 113 is, for example, a through-hole penetrating the jig 110 along the axial direction X and is formed in a substantially elliptical annulus shape along an outer surface of the projecting portion 22.

In addition, the jig 110 includes, for example, the sealing surface 111 and groove portions 112. The sealing surface 111 is a side surface of the jig 110 on the other end portion side (the gasket 30 side) in the axial direction X. For example, the sealing surface 111 faces, at a peripheral edge portion of the insertion hole 113, the one end surface 30a of the gasket 30 in the axial direction X. Specifically, in a case where the gasket 30 is assembled to the recess 24 of the housing 20 in the above-described incorrect posture, the sealing surface 111 faces the one end surface 30a of the gasket 30 on the lip portion 31 side. On the other hand, in a case where the gasket 30 is assembled to the recess 24 of the housing 20 in the above-described correct posture, the sealing surface 111 faces the other flat end surface 30b of the gasket 30 on an opposite side to the lip portion 31.

For example, the groove portion 112 reduces the sealability (compression amount of the gasket 30) between the sealing surface 111 and the one end surface 30a by accommodating at least a part of the lip portion 31 provided on the gasket 30. The groove portion 112 is recessed from the sealing surface 111 toward the one end portion side in the axial direction X (toward an opposite side to the gasket 30) and is open toward the other end portion side in the axial direction X. The groove portions 112 are provided in the peripheral edge portion of the insertion hole 113 in the sealing surface 111 and face the gasket 30 along the axial direction X. For example, a depth of the groove portion 112 along the axial direction X is set to be larger than a projecting amount (length) of the lip portion 31 along the axial direction X.

Here, in the embodiment, the sealing surface 111 has the plurality of the groove portions 112 at intervals along a circumferential direction of the gasket 30 and enables the lip portions 31 to be partially accommodated in the groove portions 112. Specifically, in the embodiment, the three groove portions 112 are provided at intervals along the width direction Y on both sides of the sealing surface 111 in the height direction Z with the insertion hole 113 interposed therebetween. For example, each of the plurality of groove portions 112 is set to have a length to the extent that the two lip portions 31 can be partially accommodated, within a width of the gasket 30 along the radial direction (the height direction Z). Note that the number and layout of the groove portions 112 are not limited to this example and can be variously changed.

In addition, in the embodiment, the groove portions 112 are inclined with respect to the radial direction (the height direction Z) of the gasket 30. Specifically, in the embodiment, the three groove portions 112 positioned on one end portion side (an upper side) of the sealing surface 111 in the height direction Z are inclined toward one end portion side in the width direction Y as being close to the one end portion side in the height direction Z. On the other hand, the three groove portions 112 positioned on the other end portion side (a lower side) of the sealing surface 111 in the height direction Z are inclined toward the one end portion side in the width direction Y as being close to the other end portion side in the height direction Z. That is, in the embodiment, groups of the three groove portions 112 facing each other along the height direction Z are formed line-symmetrically with respect to an imaginary line which passes through a center of the insertion hole 113 and extends along the width direction Y.

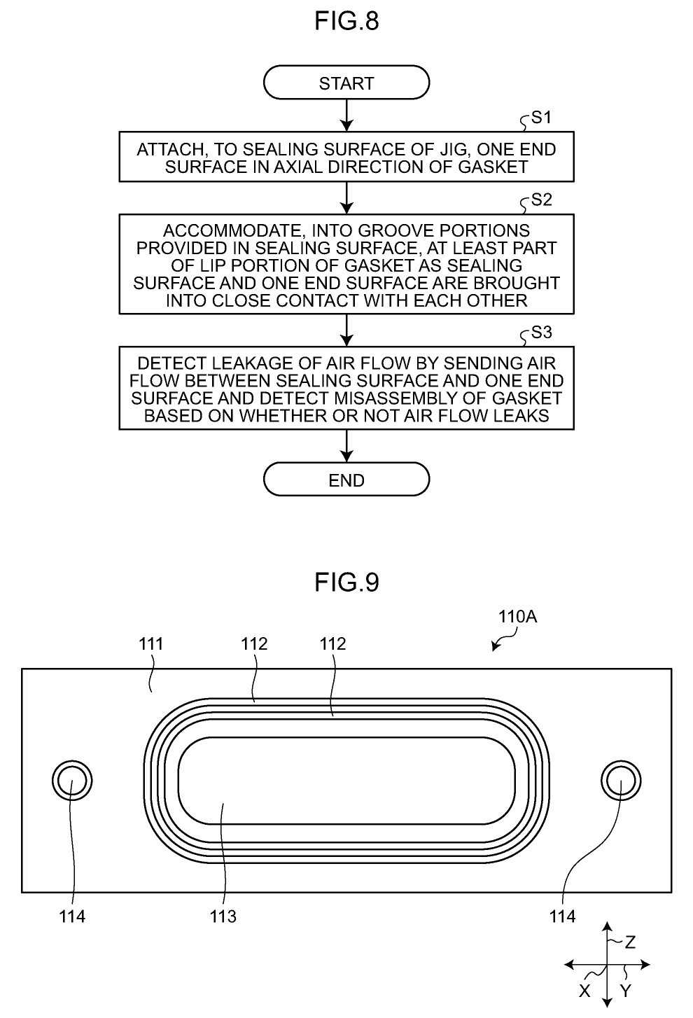

Next, an example of a method for detecting misassembly of the gasket 30 having the configuration described above will be described. FIG. 7 is a cross-sectional view illustrating the method for detecting misassembly of the gasket 30, and FIG. 8 is a flowchart of the method for detecting misassembly of the gasket 30. As illustrated in FIGS. 7 and 8, first, in a process of a first step S1, the one end surface 30a in the axial direction X of the gasket 30 assembled to the housing 20 of the terminal block 1 is attached to the sealing surface 111 of the jig 110. In this case, for example, the attachment holes 114 of the above-described jig 110 and the housing 20 are fastened by a fastening member, whereby the gasket 30 is attached to the sealing surface 111.

Next, in a process of a second step S2, as illustrated in FIGS. 7 and 8, as the sealing surface 111 and the one end surface 30a are brought into close contact with each other, at least a part of the lip portion 31 of the gasket 30 projecting from the one end surface 30a along the axial direction X is accommodated in the groove portions 112 provided in the sealing surface 111. In this case, for example, a surface pressure between the sealing surface 111 and the one end surface 30a increases as the attachment holes 114 of the jig 110 and the housing 20 are fastened (screwed) by the fastening member, and eventually, at least a part of the lip portion 31 falls into the groove portion 112.

Next, in a process of a third step S3, as illustrated in FIGS. 7 and 8, the air flow W is sent between the sealing surface 111 and the one end surface 30a from the air leak tester 120 to detect leakage of the air flow W, and misassembly of the gasket 30 is detected based on whether or not the air flow W leaks. In this case, for example, the air flow W is sent into the insertion hole 113 of the jig 110 by the air leak tester 120 from the one end portion side of the jig 110 in the axial direction X (from the opposite side to the gasket 30). The air flow W flows along the axial direction X through the insertion hole 113 as an inside of a device, is bent along the width direction Y by abutting on an end surface of the housing 20, and flows from a gap between the sealing surface 111 and the end surface of the housing 20 and the gasket 30 to the outside of the device which is the outer side of the housing 20.

At this time, in the embodiment, since the groove portions 112 capable of accommodating at least a part of the lip portion 31 are provided in the sealing surface 111, the sealability (compression amount of the gasket 30) between the sealing surface 111 and the one end surface 30a decreases in a state in which the lip portion 31 is assembled in an incorrect posture toward the sealing surface 111 side as compared with a state in which the lip portion 31 is assembled to the recess 24 of the housing 20 in a correct posture toward the bottom surface side of the recess 24. Consequently, the air flow W is likely to leak between the sealing surface 111 and the one end surface 30a to the outside of the housing 20, and eventually, misassembly of the gasket 30 can be detected based on whether or not the air flow W leaks. By the first step S1 to the third step S3, misassembly of the gasket 30 can be detected.

As described above, the jig 110 of the embodiment includes the sealing surface 111 facing the one end surface 30a in the axial direction X of the gasket 30 assembled to the housing 20 of the terminal block 1, and the groove portions 112 that are provided in the sealing surface 111 and are capable of accommodating at least a part of the lip portion 31 projecting along the axial direction X from the one end surface 30a of the gasket 30. According to this configuration, in the jig 110, for example, since the sealability (compression amount of the gasket 30) between the sealing surface 111 and the one end surface 30a decreases in a state in which at least a part of the lip portion 31 is assembled in the groove portions 112 in an incorrect posture, the air flow W leaks between the sealing surface 111 and the one end surface 30a, and misassembly of the gasket 30 can be detected based on whether or not the air flow W leaks. As a result, the jig 110 can appropriately perform operation for detecting misassembly of the gasket 30.

In addition, in the jig 110 of the embodiment, the lip portion 31 is formed in an annular shape along the gasket 30, and the sealing surface 111 has the plurality of groove portions 112 at intervals along the circumferential direction of the gasket 30 and enables the lip portion 31 to be partially accommodated in the groove portions 112. According to this configuration, in the jig 110, for example, a plurality of outflow paths of the air flow W are formed between the groove portions 112 and the lip portions 31, and the air flow W more easily leaks between the sealing surface 111 and the one end surface 30a, and eventually, the operation for detecting misassembly of the gasket 30 can be more appropriately performed.

In addition, in the jig 110 of the embodiment, the groove portions 112 are inclined with respect to the radial direction (the height direction Z) of the gasket 30. According to this configuration, in the jig 110, for example, since the groove portions 112 can be formed longer within the width of the gasket 30 along the radial direction, the air flow W more easily leaks between the sealing surface 111 and the one end surface 30a, and eventually, the operation for detecting misassembly of the gasket 30 can be more appropriately performed.

In addition, the method for detecting misassembly of the gasket 30 of the embodiment includes the first step S1 of attaching, to the sealing surface 111 of the jig 110, the one end surface 30a in the axial direction X of the gasket 30 assembled to the housing 20 of the terminal block 1, the second step S2 of accommodating, into the groove portions 112 provided in the sealing surface 111, at least a part of the lip portion 31 of the gasket 30 projecting along the axial direction X from the one end surface 30a as the sealing surface 111 and the one end surface 30a are brought into close contact with each other, and the third step S3 of detecting leakage of the air flow W by sending the air flow W between the sealing surface 111 and the one end surface 30a from an air leak tester 120, and detecting misassembly of the gasket 30 based on whether or not the air flow W leaks. According to this configuration, in the method for detecting misassembly of the gasket 30, for example, since the sealability (compression amount of the gasket 30) between the sealing surface 111 and the one end surface 30a decreases in a state in which at least a part of the lip portion 31 is assembled in the groove portions 112 in an incorrect posture, the air flow W leaks between the sealing surface 111 and the one end surface 30a, and misassembly of the gasket 30 can be detected based on whether or not the air flow W leaks. As a result, the method for detecting misassembly of the gasket 30 can appropriately perform operation for detecting misassembly of the gasket 30.

### Modification Example

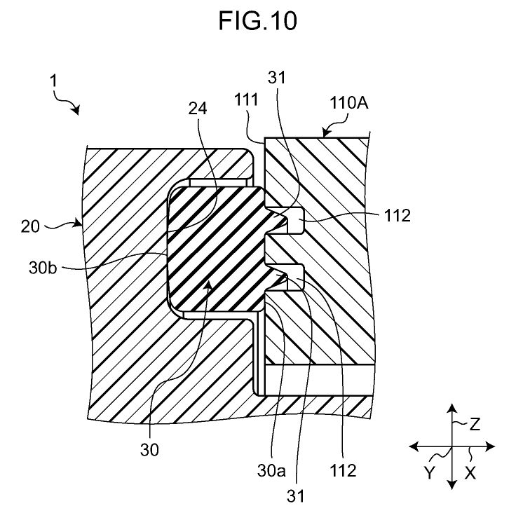

FIG. 9 is a perspective view of a jig 110A according to a modification example, and FIG. 10 is a cross-sectional view of the jig 110A and the gasket 30 of the terminal block 1 according to the modification example. The jig 110A illustrated in FIGS. 9 and 10 has the same configuration as that of the jig 110 of the above-described embodiments. Therefore, the jig 110A can obtain the same operation and effect as those of the above-described embodiments based on the same configuration.

However, as illustrated in FIGS. 9 and 10, the modification example is different from the above-described embodiments in that annular groove portions 112 along the gasket 30 are provided in the sealing surface 111 of the jig 110A, and the entire circumferences of the lip portions 31 are accommodated in the groove portions 112. Specifically, in the modification example, the two annular groove portions 112 corresponding to the two respective lip portions 31 are provided in the sealing surface 111 at intervals along the radial direction of the gasket 30. Note that the number of the groove portions 112 is not limited to this example and can be variously changed.

For example, the groove portions 112 reduce the sealability (compression amount of the gasket 30) between the sealing surface 111 and the one end surface 30a by accommodating the entire circumferences of the lip portions 31 provided on the gasket 30. The groove portion 112 is recessed from the sealing surface 111 toward the one end portion side in the axial direction X (toward an opposite side to the gasket 30) and is open toward the other end portion side in the axial direction X. The groove portions 112 are provided in the peripheral edge portion of the insertion hole 113 in the sealing surface 111 and face the gasket 30 along the axial direction X. That is, the two groove portions 112 are positioned within the width of the gasket 30 along the radial direction. For example, a depth of the groove portion 112 along the axial direction X is set to be larger than a projecting amount (length) of the lip portion 31 along the axial direction X.

As described above, in the jig 110A of the modification example, the lip portions 31 are formed in an annular shape along the gasket 30, and the sealing surface 111 has the groove portions 112 having an annular shape along the gasket 30 and enables the entire circumferences of the lip portions 31 to be accommodated in the groove portions 112. According to this configuration, in the jig 110A, for example, the entire circumferences of the lip portions 31 fall into the annular groove portions 112, whereby the sealability (compression amount of the gasket 30) between the sealing surface 111 and the one end surface 30a can be reduced. As a result, in the jig 110A, the air flow W easily leaks between the sealing surface 111 and the one end surface 30a, and eventually, the operation for detecting misassembly of the gasket 30 can be more appropriately performed.

Note that, in the modification example and the above-described embodiments, the case where the gasket 30 has the two lip portions 31 provided side by side in the radial direction of the gasket 30 has been exemplified, but the invention is not limited to this example. For example, three or more lip portions 31 may be provided side by side in the radial direction, or one lip portion 31 may be provided. In this case, in the jigs 110 and 110A, the number and a length of the groove portions 112 are set to correspond to the lip portion 31.

Although the embodiments and the modification example of the present invention have been exemplified above, the embodiments and the modification example are merely examples and are not intended to limit the scope of the invention. The above-described embodiments and modification example can be implemented in various other embodiments, and various omissions, substitutions, combinations, and changes can be performed without departing from the gist of the invention. In addition, specifications (a structure, a type, a direction, a format, a size, a length, a width, a thickness, a height, the number, an arrangement, a position, a material, or the like) of each configuration, shape, or the like can be appropriately changed and implemented.

The jig and the method for detecting misassembly of the gasket according to the present embodiment are effective in that operation for detecting misassembly of the gasket can be appropriately performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A jig comprising:
a sealing surface that faces one end surface in an axial direction of a gasket assembled to a housing of a terminal block; and
groove portions that are provided in the sealing surface and are capable of accommodating at least a part of a lip portion projecting from the one end surface of the gasket along the axial direction.

2. The jig according to claim 1, wherein
the lip portion is formed in an annular shape along the gasket, and
the sealing surface has a plurality of the groove portions at intervals along a circumferential direction of the gasket and enables the lip portion to be partially accommodated in the groove portions.

3. The jig according to claim 2, wherein
the groove portions are inclined with respect to a radial direction of the gasket.

4. The jig according to claim 1, wherein
the lip portion is formed in an annular shape along the gasket, and
the sealing surface has the groove portions having an annular shape along the gasket and enables an entire circumference of the lip portion to be accommodated in the groove portions.

5. A method for detecting misassembly of a gasket, the method comprising:
a first step of attaching, to a sealing surface of a jig, one end surface in an axial direction of a gasket assembled to a housing of a terminal block;
a second step of accommodating, into groove portions provided in the sealing surface, at least a part of a lip portion of the gasket projecting along the axial direction from the one end surface as the sealing surface and the one end surface are brought into close contact with each other; and
a third step of detecting leakage of an air flow by sending the air flow between the sealing surface and the one end surface from an air leak tester, and detecting misassembly of the gasket based on whether or not the air flow leaks.
